(19) United States
(12) Patent Application Publication
(10) Pub. No.: US 2026/0025669 A1
(43) Pub. Date: Jan. 22, 2026

(54) SYSTEMS AND METHODS FOR AUTOMATED MODIFICATION OF WIRELESS NETWORKS

(71) Applicant: PLUME DESIGN, INC., Palo Alto, CA (US)

(72) Inventors: Adam HOTCHKISS, Dallas, TX (US); Paul H. WHITE, San Carlos, CA (US); Naveen ANCHA, Milpitas, CA (US)

(21) Appl. No.: 18/776,319

(22) Filed: Jul. 18, 2024

(51) Int. Cl. H04W 16/22; H04L 43/0811; H04W 24/10; H04W 88/16

(52) U.S. Cl. CPC H04W 16/22; H04L 43/0811; H04W 24/10; H04W 88/16

(57) ABSTRACT

According to some embodiments, the disclosed method includes (i) configuring a wireless network, (ii) connecting, via the network, one or more network extenders to the network gateway, (iii) connecting one or more client devices to the wireless network, (iv) performing one or more network test operations on the wireless network, (v) determining, during the network test operations, connectivity throughput of the connection between each client device and the wireless network, and (vi) causing control of one or more of the one or more client devices, the one or more network extenders, or the network gateway based on the determined connectivity throughput between each client device and the wireless network.

### BACKGROUND

Wireless networks can include a variety of devices for providing network connectivity to client devices such as laptops, mobile phones, etc. For example, a gateway device can connect to extenders over a backhaul network, with the gateway connecting to a larger network such as the Internet while the extenders and/or the gateway itself provide local connectivity to client devices. However, such networks must be able to adapt to changing conditions in order to provide optimal service to the client devices.

### BRIEF DESCRIPTION OF THE DRAWINGS

The accompanying drawings illustrate several example implementations and are a part of the specification. Together with the following description, these drawings demonstrate and explain various principles of the present disclosure.

FIG. 1 is a block diagram of an example device for automated modification of wireless networks.

FIG. 2 is a schematic diagram of an example system for automated modification of wireless networks.

FIG. 3 is a block diagram of an example method for automated modification of wireless networks.

FIG. 4 is a block diagram of an example arrangement of devices for performing network interference network tests involved in automated modification of wireless networks.

FIG. 5 is a block diagram of an example arrangement of devices for performing client steering network tests involved in automated modification of wireless networks.

FIG. 6 is a block diagram of an example arrangement of devices for performing roaming reconnection network tests involved in automated modification of wireless networks.

FIG. 7 is a block diagram of an additional example arrangement of devices for performing roaming reconnection network tests involved in automated modification of wireless networks.

FIG. 8 is a block diagram of an example arrangement of devices for performing peripheral coverage tests for automated modification of wireless networks.

FIG. 9 is a block diagram of an example arrangement of devices in a linear topology for performing network tests involved in automated modification of wireless networks.

Throughout the drawings, identical reference characters and descriptions indicate similar, but not necessarily identical, elements. While the example implementations described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to systems and methods for automated modification of wireless networks. Wireless networks can include complex topologies, involving multiple access points such as gateways and/or extenders as well as multiple client devices that may or may not be stationary. Wireless networks therefore benefit from adaptable behavior capable of maximizing connectivity throughput to any given device that is connected to the network, even in the face of interference from other networks.

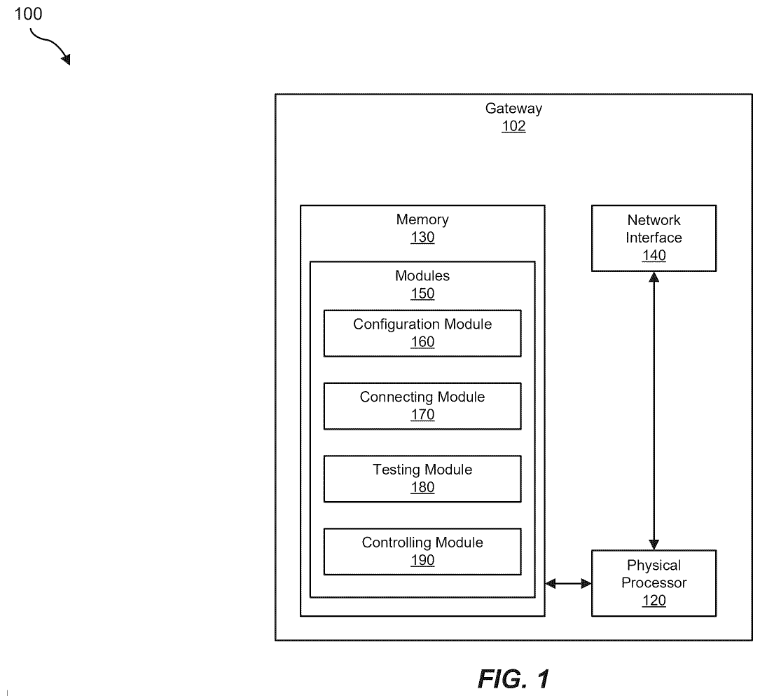

FIG. 1 is a block diagram of an example system 100 for automated modification of wireless networks. As illustrated in this figure, example system 100 may include one or more modules 150 for performing one or more tasks. For example, and as will be explained in greater detail below, example system 100 may include a configuration module 160 that configures, via gateway 102, a wireless network. Example system 100 may additionally include a connecting module 170 that (i) communicatively connects, via the wireless network, one or more network extenders to gateway 102 and (ii) communicatively connects, via the wireless network, one or more client devices to an access point comprising at least one of the network extenders or gateway 102. Example system 100 may also include a testing module 180 that (i) performs one or more network test operations on the wireless network and (ii) determines, during each of the one or more network test operations and for each of the one or more client devices, a connectivity throughput of the communicative connection between each client device and the wireless network. Example system 100 may further include a controlling module 190 that causes control of one or more of the one or more client devices, the one or more network extenders, or the network gateway based on the determined connectivity throughput. Although illustrated as separate elements, one or more of modules 150 in FIG. 1 may represent portions of a single module or application.

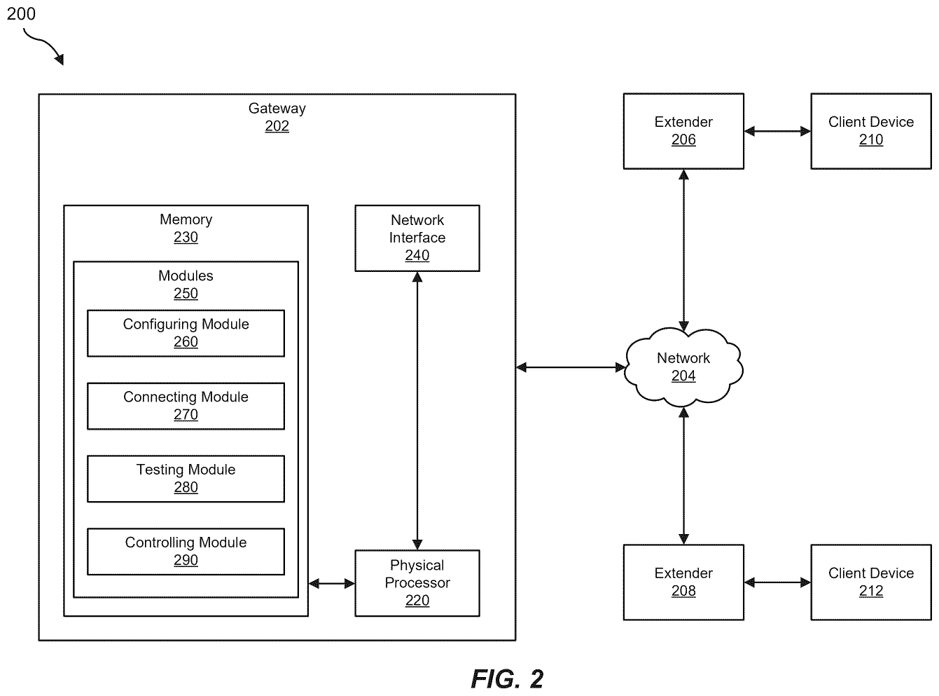

In certain embodiments, one or more of modules 150 in FIG. 1 may represent one or more software applications or programs that, when executed by a computing device, may cause the computing device to perform one or more tasks. For example, and as will be described in greater detail below, one or more of modules 150 may represent modules stored and configured to run on one or more computing devices, such as gateway 202 illustrated in FIG. 2. One or more of modules 150 in FIG. 1 may also represent all or portions of one or more special-purpose computers configured to perform one or more tasks.

As illustrated in FIG. 1, example system 100 may also include one or more memory devices, such as memory 130. Memory 130 generally represents any type or form of volatile or non-volatile storage device or medium capable of storing data and/or computer-readable instructions. In one example, memory 130 may store, load, and/or maintain one or more of modules 150. Examples of memory 130 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 120. Physical processor 120 generally represents any type or form of hardware-implemented processing unit capable of interpreting and/or executing computer-readable instructions. In one example, physical processor 120 may access and/or modify one or more of modules 150 stored in memory 130. Additionally or alternatively, physical processor 120 may execute one or more of modules 150 to facilitate automated modification of the wireless network. Examples of physical processor 120 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

Gateway 102 generally represents any device configured to connect different networks. For example, gateway 102 may be configured to connect a local area network (LAN) to the Internet or configured to connect a local wireless network to a larger network. In some embodiments, gateway 102 may also include router functionality to deliver data within the local network. Gateway 102 may include a variety of hardware to facilitate this functionality, such as one or more network interfaces including network interface 140. Gateway 102 may include a variety of other input and/or output mechanisms, such as support for Ethernet connections, and may further include software for translating different network protocols.

Example system 100 in FIG. 1 may be implemented in a variety of ways. For example, all or a portion of example system 100 may represent portions of example system 200 as illustrated in FIG. 2. As shown in FIG. 2, system 200 may include a gateway 202, which may be functionally similar to gateway 102 as described above. Gateway 202 may include a network interface 240 that facilitates communication with other devices via network 204, memory 230 that stores one or more software modules (illustrated as modules 250), and physical processor 220 that executes one or more of modules 250.

Client devices 210 and 212 generally represent any type or form of computing device capable of reading computer-executable instructions and communicating over a network. In some embodiments, client device 210 and/or client device 212 may represent a personal computing device. Examples of client devices include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device. Client devices may communicate with each other and/or other remote devices via a network, such as a wireless network.

As in FIG. 2, network 204 generally represents any medium or architecture capable of facilitating communication or data transfer. In one example, network 204 may facilitate communication between client device 210, client device 212, extender 206, extender 208, and/or gateway 202. In this example, network 204 may facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

Extender 206 and extender 208 generally represent any networking hardware capable of extending the range of a wireless network. Network extenders may also be referred to as repeaters, leaves, or leaf nodes. Network extenders are configured to receive communicative connections from a gateway device such as a router and re-transmit data to endpoints such as client devices 210 and 212. In some examples, extenders 206 and 208 may be connected to gateway 202 via a wireless connection. In further examples, one or more extenders may be connected to gateway 202 via wired connections.

As illustrated in FIG. 2, gateway 202 may be configured to store computer-executable instructions in memory 230. These instructions are illustrated as modules 250, and include a configuration module 260, connecting module 270, testing module 280, and controlling module 290, the functions of which will be described in greater detail below. Gateway 202 can also include one or more physical processors, though is illustrated in this example as including a physical processor 220. Gateway 202 can further include a network interface 240 that facilitates communication with other devices such as extenders 206 and/or 208, and possibly client devices 210 and/or 212 as well.

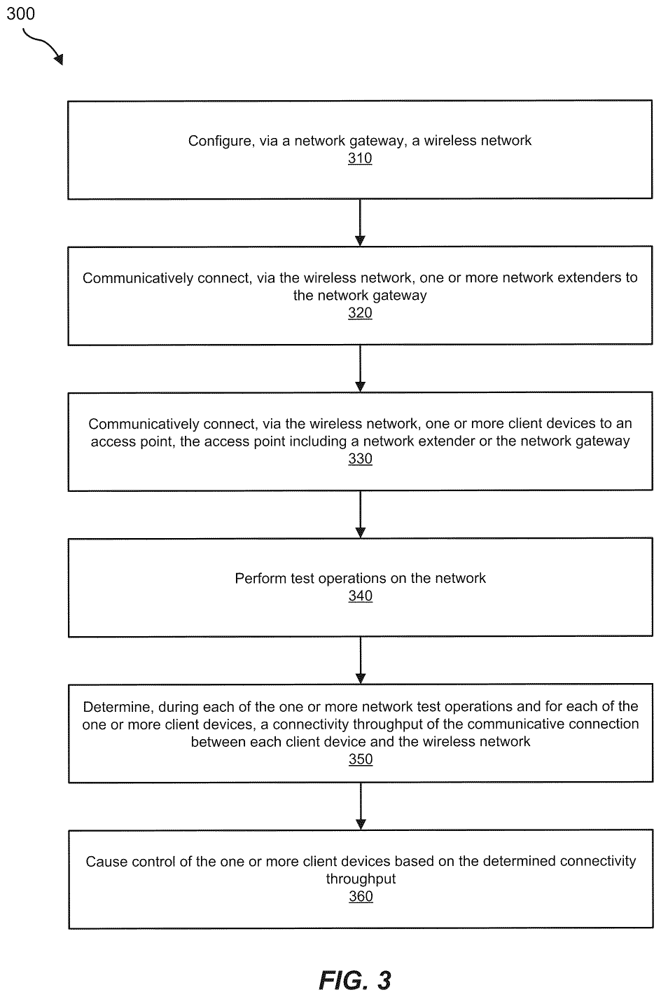

FIG. 3 is a block diagram of an example computer-implemented method 300 for automated modification of wireless networks. The steps shown in FIG. 3 may be performed by any suitable computer-executable code and/or computing system, including system 100 in FIG. 1, system 200 in FIG. Error! Reference source not found., and/or variations or combinations of one or more of the same. In one example, each of the steps shown in FIG. 3 may represent an algorithm whose structure includes and/or is represented by multiple sub-steps, examples of which will be provided in greater detail below.

As illustrated in FIG. 3, at step 310, one or more of the systems described herein may configure, via a network gateway, a wireless network. For example, configuring module 260 may, as part of gateway 202 in FIG. 2, configure network 204 and/or network interface 240 for communication with other devices.

Gateway 202 may perform a variety of functions as part of configuring network 204. In some examples, gateway 202 may begin broadcasting network information, such as an SSID, access point name, channels used for various connections and/or connection types, or other information in the case of a wireless network, to enable other devices to connect to network 204.

Returning to FIG. 3, at step 320, one or more of the systems described herein may communicatively connect, via the wireless network, one or more network extenders to the network gateway. For example, connecting module 270 may, as part of gateway 202 in FIG. 2, communicatively connect extender 206 and/or extender 208 to gateway 202 via network 204.

Extenders may be connected to gateway 202 in a variety of ways. In some embodiments, extender 206 and/or extender 208 may be connected to gateway 202 via a physical or wired connection. In further embodiments, extender 206 and/or extender 208 may be connected to gateway 202 via a wireless connection, such as over a Wi-Fi network configured by gateway 202. In some embodiments, the connection may be initiated at gateway 202. In these embodiments, gateway 202 may detect network extenders in range and begin transmitting and/or receiving network data from the extenders. Additionally or alternatively, the connection may be initiated at the extenders. For example, an extender may detect that a gateway in signal range (e.g., gateway 202) is broadcasting an SSID or other information that identifies a wireless network, join the network, and begin exchanging data with the gateway to facilitate extension of the wireless network. In some examples, a user may manually configure the gateway and/or one or more of the extenders to facilitate connecting the extenders to the gateway. Additionally or alternatively, the gateway and/or the extenders may automatically facilitate connecting the extenders to the gateway. In some examples, an extender may connect to the network and/or the gateway indirectly, e.g., by connecting to another extender that itself is connected to the gateway.

Returning to FIG. 3 at step 330, one or more of the systems described herein may communicatively connect, via the wireless network, one or more client devices to an access point, the access point including a network extender or the network gateway. For example, connecting module 270 may, as part of gateway 202 in FIG. 2, communicatively connect client devices 210 and 212 to extender 206, extender 208, and/or gateway 202.

Client devices may be connected to their respective access points in a variety of ways. In some embodiments, operating systems, diagnostic tools, and/or other software installed on the client devices may automatically connect, via a network interface, the client device to a network, such as a wireless network. The specific access point that the client device connects to may be determined by a variety of factors, including the configuration of the wireless network, the networking hardware involved in facilitating the wireless network, the configuration of the client device, etc. and may be based on a variety of factors such as received signal strength indicators (RSSIs) detected at the client device for each relevant access point. In some embodiments, the systems and methods described herein may prescribe which access point a particular client device should connect to. In some embodiments, testing module 280 may explicitly direct certain client devices to connect to specific access points. Additionally or alternatively, testing module 280 may allow client devices to connect to appropriate access points as dictated by software installed on the client devices and/or access points.

Returning to FIG. 3 at step 340, one or more of the systems described herein may perform test operations on the network. For example, testing module 280 may, as part of gateway 202 in FIG. 2, perform test operations on network 204.

Additionally, at step 350, one or more of the systems described herein may determine, during each of the one or more network test operations and for each of the one or more client devices, a connectivity throughput of the communicative connection between each client device and the wireless network. For example, testing module 280 may, as part of gateway 202, determine, during one or more of the network test operations and for each of client devices 210 and 212, a connectivity throughput of the communicative connection between the client device and network 204.

Testing module 280 may perform a variety of network tests on network 204, depending on the exact configuration of the devices involved. In some embodiments, testing module 280 may prompt a user to reconfigure, relocate, reposition, and/or physically add or remove devices such as extenders and client devices from the physical testing area. The physical testing area may be any physical space in which to test the capabilities of network hardware, such as a home, an office, a dedicated testing environment, etc.

In some embodiments, testing module 280 may establish baseline parameters before beginning the testing process. For example, testing module 280 may establish a baseline connectivity throughput (e.g., upload and/or download data transfer rates), baseline latency, map a pre-test network topology, or any other aspect or metric of network 204 that might change during testing. These baseline metrics may be established in the absence of any additional factors that may be introduced during testing, such as wireless interference from another network, moving client devices, unusual arrangements of client devices, designation of a priority device, etc. Furthermore, baseline network metrics may be established after waiting a certain amount of time (e.g., 10 minutes or 20 minutes) after the initial network setup and connecting all devices necessary for a particular test to ensure that network conditions have settled and/or stabilized before establishing the baseline metrics.

As will be described in greater detail below, testing module 280 may monitor network metrics and/or conditions during and after testing in addition to baseline metrics, and record these metrics for later evaluation of the network. Testing module 280 may record the baseline metrics, any metrics s measured during testing, and/or any metrics measured after testing for use by other modules in the system. Testing module 280 may also record metrics with respect to extender devices and/or the gateway device itself instead of only recording metrics with respect to the client devices.

As will be described in greater detail below, testing module 280 may conduct a variety of network tests on network 204 in order to evaluate how the network and/or connected devices (such as extenders, client devices, and/or the gateway) respond to changing network conditions or unusual network topologies (e.g., linear topologies). In some embodiments, testing module 280 may require devices to be physically placed in a specific arrangement in order to properly perform one or more network tests. In these embodiments, testing module 280 may, via a user interface of a device and prior to establishing pre-test baselines and/or prior to beginning the test, prompt a user or human tester to reposition one or more devices so as to physically configure the locations of the devices for testing. Additionally or alternatively, testing module 280 may indicate a desired layout of devices, additional networks to be configured, etc. necessary to perform the test.

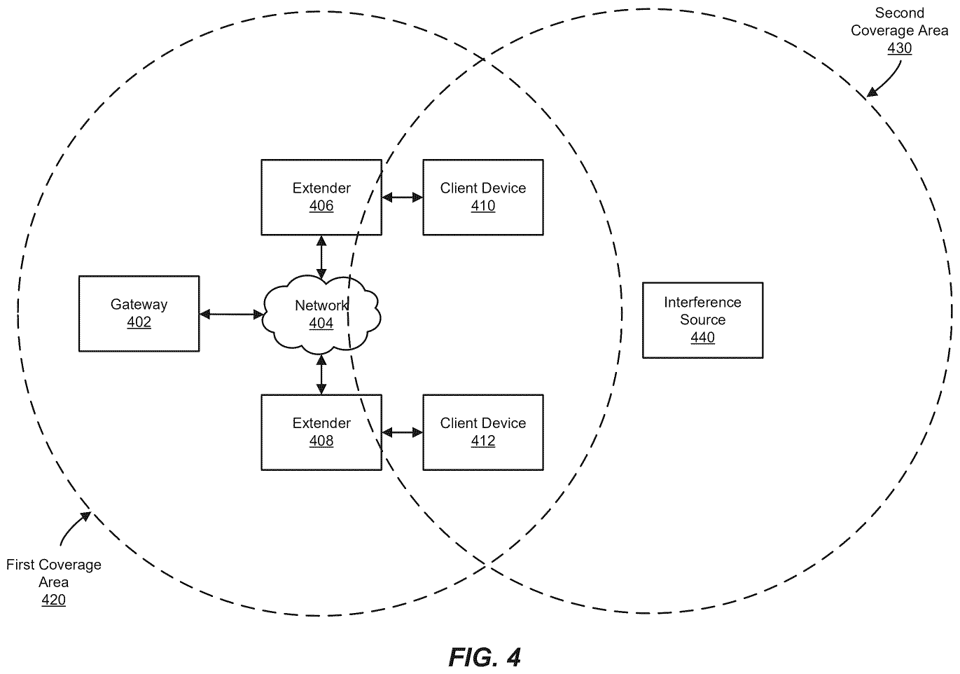

In some examples, module 280 may perform a network interference response test. An example configuration of devices for performing network interference response tests is shown in FIG. 4. In the example of FIG. 4, a device layout for performing network interference response tests includes a gateway, one or more extenders, and one or more client devices all connected via a wireless network. In the specific example of FIG. 4, a gateway 402 is in communication with two extenders, illustrated as extender 406 and extender 408, via a network 404 as configured and managed by gateway 402, though in this test and the other tests described herein, any suitable number or topology of client devices and extenders could be used (e.g., three extenders and six client devices). In the example illustrated in FIG. 4, which uses two extenders and two client devices, extender 406 is communicatively connected to client device 410, while extender 408 is communicatively connected to client device 412. Network 404 may, by a combination of extender 406, extender 408, and gateway 402 provide wireless network coverage within first coverage area 420. Meanwhile, a second network may be configured to cause interference with network 404. This second network, illustrated as interference source 440, can include any suitable number or arrangement of devices, and have a second coverage area 430 that overlaps with first coverage area 420. Ideally, one or more client devices and/or extenders will be physically situated within the area of overlap between first coverage area 420 and second coverage area 430. In the example of FIG. 4, client device 410 and client device 412 are both within the overlap region.

Furthermore, network 404 and interference source 440 may be configured to operate within a similar frequency band and/or channel for some or all of their connections. For example, both networks may be configured to use the same channel for connections that carry fronthaul and/or backhaul network communications, and further be configured to use the same bandwidth. By selecting the specific channel used to carry a particular kind of communication, the systems and methods described herein may selectively introduce interference into the connections that carry those communications. For example, by configuring both the primary network (i.e., the network used to perform the tests described herein, or network 404) and secondary network (i.e., the network used to introduce interference into the primary network, or interference source 440) to use the same channel for backhaul communications, the secondary network may selectively introduce interference into the backhaul connections of the primary network. Similarly, configuring the primary network and the secondary network to use the same channel for fronthaul connections, the secondary network may selectively introduce interference into the fronthaul connections of the primary network.

The particular arrangement of devices illustrated in FIG. 4 is merely one example of a possible device layout for conducting a network interference test; a variety of other configurations could be used. For example, additional client devices positioned throughout the testing space could be included, as could any suitable number of extenders. Similarly, the client devices and/or extenders could be positioned in any suitable location relative to gateway 402, and gateway 402 itself may be positioned in any suitable fashion within the testing space. Likewise, interference source 440 may be placed in any position within the testing space so long as second coverage area 430 at least partially overlaps with first coverage area 420, and at least one client device is within the overlap between the two coverage areas. In some embodiments, some client devices may be positioned within first coverage area 420 but outside second coverage area 430.

Once the devices are positioned and the respective networks (e.g., network 404 and interference source 440) have been configured, testing module 280 may establish baseline metrics for one or more devices as described above. Once the baseline metrics have been established, testing module 280 may prompt interference source 440 (or a user to manually activate interference source 440) to cause interference with network 404. This interference may take a variety of forms. In one embodiment, interference source 440 may generate interference by uploading and/or downloading large volumes of data via the network of interference source 440. Additionally or alternatively, interference source 440 may generate network interference by repeatedly sending frequent network pings.

Once the devices described above have been properly arranged, testing module 280 may determine connectivity throughput and/or measure any other metrics (e.g., network topology and/or connection latency) for one or more devices. In some examples, testing module 280 may evaluate connectivity throughput over time (e.g., before, during, and after the introduction of interference) and/or at specific intervals (e.g., every 1, 5, or 10 seconds, 10 minute, 20 minutes, or any other suitable interval of time) for each client device. Testing module 280 may record the connectivity throughput and/or other metrics (e.g., channels used for fronthaul and/or backhaul communications) in a variety of formats, including but not limited to CSV, JSON, or other suitable formats. Networks that are capable of adapting to signal interference by, e.g., dynamically changing channels, are expected to be less impacted by signal interference than networks that do not have such capabilities.

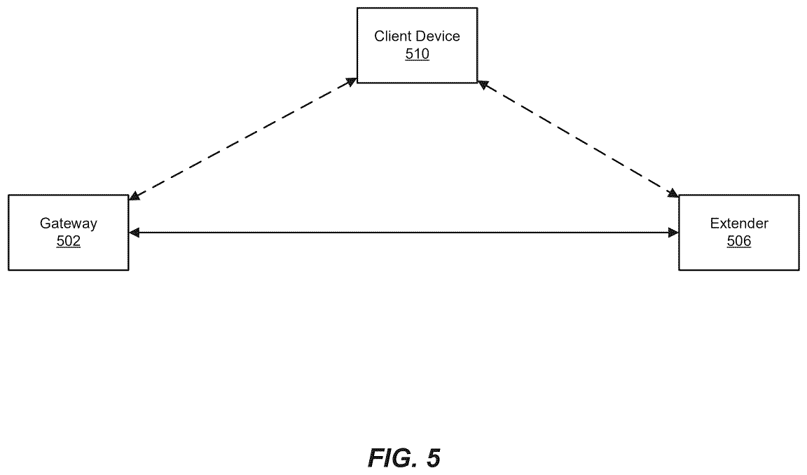

In some embodiments, testing module 280 may perform a client steering test to verify whether the network is capable of steering stationary client devices to an appropriate access point, e.g., the access point that will provide the greatest connectivity throughput to the client device. In this example, testing module 280 may request that devices be arranged according to the example network illustrated in FIG. 5. In this example, a gateway 502 is communicatively connected to extender 506 to provide network coverage across a physical space. Client device 510 is situated such that the relative signal strengths (measured, e.g., by received signal strength indicator or RSSI) from gateway 502 and extender 506 as measured at client device 510 are within a predetermined threshold of each other. Using RSSI as a measurement scale, client device 510 may be positioned such that the RSSI from gateway 502 is 5 dBm, 10 dBm, 15 dBm, or any other suitable amount less than the RSSI from extender 506. In some embodiments, client device 510 may be positioned such that the signal strength received from extender 506 is slightly greater than the signal strength received from gateway 502. As a specific example and using RSSI as a measurement scale, client device 510 may be positioned such that the RSSI of gateway 502 is between 5 and 10 dBm less than the RSSI from extender 506. However, any other suitable measurement scale and difference in relative signal strengths may be used. Testing module 280 may determine which access point client device 510 has connected to and/or verify that client device 510 is connected to extender 506 before causing client device 510 to perform network activities, such as uploading or downloading data according to a predetermined scheme.

In some embodiments, as discussed herein, testing module 280 may function via instructions sent from a cloud. Thus, the instructions relayed from module 280 to an extender 506, for example, may have originated from decisions/determinations from the cloud, which are communicated to the gateway 502 for control of an extender 506. Indeed, as discussed herein, operations of method 300, while depicted as being generated via modules in gateway 202, can be caused to be performed via such modules by instructions determined, generated and/or compiled, then communicated a cloud service.

Testing module 280 may then determine connectivity throughput of the network connection for client device 510 as well as determine any other suitable aspects of the network connection and/or network as a whole as described above. For example, testing module 280 may record the network topology, channels used, client/gateway RSSI, connectivity throughput, latency, and/or communication delay. In some embodiments, testing module 280 may run a follow-up test by forcing client device 510 to connect to gateway 502 instead of extender 506 and repeating the aforementioned network tests and recording data under the new conditions. The expected result is that the network will cause client device 510 to connect to whichever access point will provide the highest performance network connection (measured, e.g., by connectivity throughput and/or latency) to client device 510.

The particular arrangement of devices illustrated in FIG. 5 is merely one example of a possible device layout for conducting a client steering test; a variety of other configurations could be used. For example, a testing network could include additional extenders, position client device 510 closer or farther away from extender 506 or at any suitable position relative to gateway 502 and/or extender 506, etc.

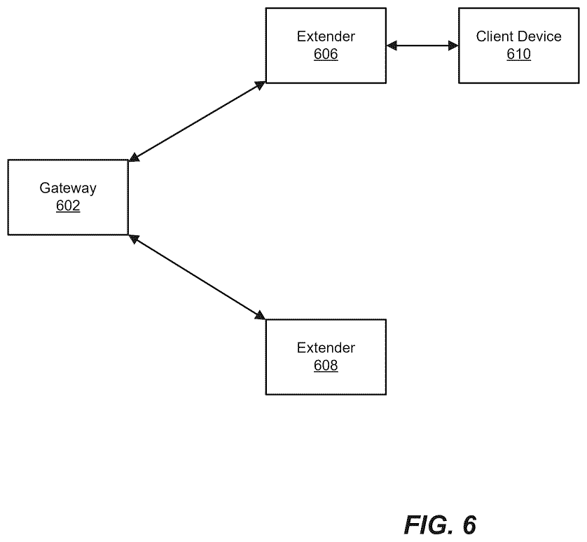

In some examples, testing module 280 may perform a roaming test to examine the network's ability to dynamically switch a client device between different access points as the device moves through the physical space covered by the network. FIG. 6 is a block diagram of a pre-test network topology for conducting such a roaming test. In this example, a gateway 602 is connected to one or more extenders. In this example, gateway 602 is communicatively connected to extender 606 and extender 608. Additionally, a client device 610 is positioned somewhere within the testing space and is communicatively connected to one of the extenders (in this case, extender 606). During the test, testing module 280 may prompt a user to physically relocate client device 610 throughout the testing space. In some examples, testing module 280 may specify a distance, direction, or route along which to move client device 610 in an attempt to force client device 610 to switch its communicative connection to a different extender (e.g., extender 608).

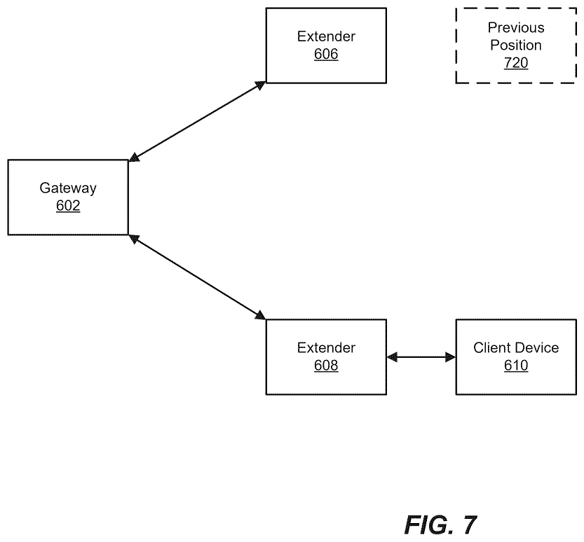

FIG. 7 is a block diagram of an example network topology during a roaming test. In this example, gateway 602 remains connected to extender 606 and extender 608. However, client device 610 has moved from previous position 720 near extender 606 to its current position near extender 608. As client device 610 moves through the physical testing area, testing module 280 may record various metrics of client device 610's connection to the network.

During a roaming test, testing module 280 may cause client device 610 to perform a variety of functions, such as transmitting network pings to a specific IP address (e.g., an address for a device upstream of gateway 602), at specified intervals as client device 610 moves through the testing area. If and when client device 610 connects to a new access point, these reconnection events may cause disruptions in the connection between client device 610 and the network. During these disruptions, results of the functions may be lost. For example, pings may be dropped or fail to reach the specific IP address while client device 610 completes its reconnection to the network via the new access point. Testing module 280 may record the results of these functions and/or monitor connectivity throughput of client device 610 as it moves about the testing area. For example, testing module 280 may determine and record, for each reconnection event, a number of network pings that fail to reach the upstream device when client device 610 reconnects to a new access point.

The particular arrangement of devices illustrated in FIGS. 6 and 7 is merely one example of a possible device layout for conducting a client roaming test; a variety of other configurations could be used. For example, any number of extenders placed according to any feasible configuration could be used. Roaming tests could include 2 extenders as shown in the example described herein, or could include 3, 4, 5, 6, or more extenders as suitable. Additionally, the testing arrangement could include walls, desks, cabinets, or other obstacles that could alter how client device 610 connects to the wireless network.

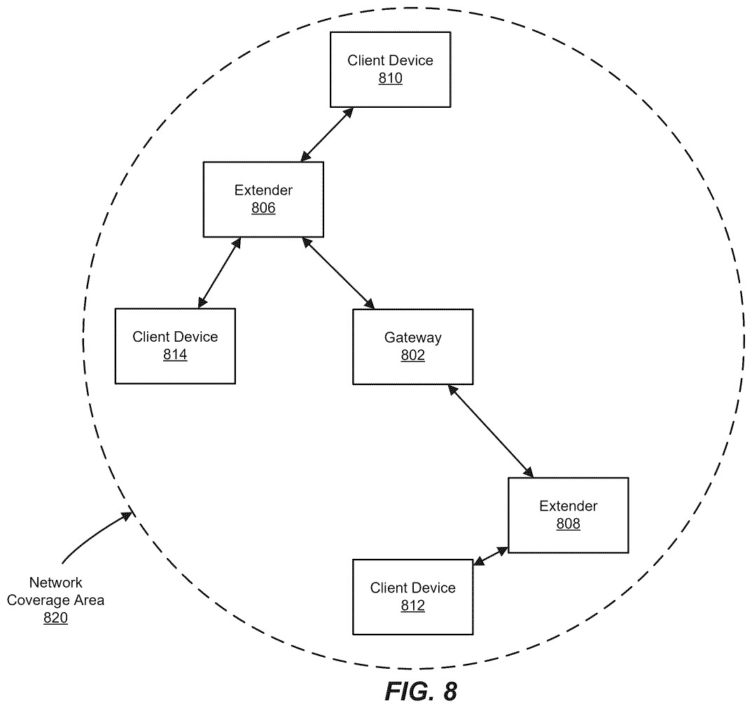

In some embodiments, testing module 280 may perform a peripheral coverage test. FIG. 8 is a block diagram illustrating an example network topology and top-down view of a layout for various devices by which to perform a peripheral coverage test. During a peripheral coverage test, testing module 280 may evaluate how the network distributes coverage throughout the coverage area. In the example illustrated in FIG. 8, gateway 802 may be connected to extender 806 and extender 808 to provide network connectivity within network coverage area 820. Client device 812 may be connected to extender 808 and positioned near the periphery of network coverage area 820. Client devices 810 and 814 may be connected to extender 806 and likewise be positioned near the periphery of network coverage area 820. In addition to devices positioned near the periphery of network coverage area 820, the test network may optionally include additional devices positioned elsewhere within network coverage area 820 to evaluate network metrics at various positions within network coverage area 820 besides the periphery.

During peripheral coverage tests, testing module 280 may perform throughput tests on connected client devices individually and/or simultaneously to test the capacity of the network to distribute network capacity across the entirety of network coverage area 820. For example, testing module 280 may simultaneously perform throughput tests on every connected client device simultaneously, particular subsets of connected client devices simultaneously, or sequentially test each connected client device. Testing module 280 may also determine and record a variety of other information relevant to these tests, such as RSSIs at each client device and/or access point, channels used, and/or network topology.

The particular arrangement of devices illustrated in FIG. 8 is merely one example of a possible device layout for conducting a peripheral coverage test; a variety of other configurations could be used. For example, the test network could include any suitable number of extenders and/or client devices arranged in any suitable configuration throughout the testing area. In some embodiments, a test network for a peripheral coverage test could include 6 or more extenders connected to gateway 802 and/or 6 or more client devices connected to various extenders that provide network coverage area 820.

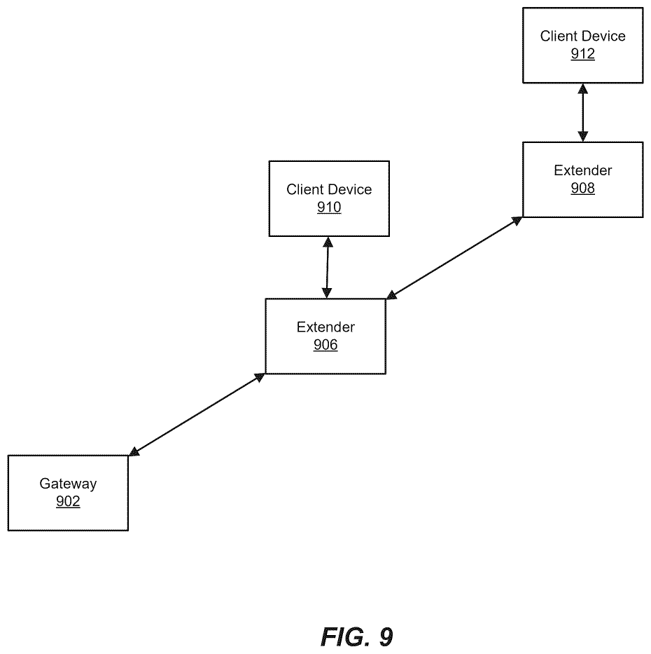

In further embodiments, testing module 280 may conduct tests on linear network topologies, e.g., network topologies in which an extender is communicatively connected to another extender rather than directly to the gateway. A block diagram of an example linear topology is shown in FIG. 9. As illustrated in FIG. 9, extender 906 is communicatively connected to gateway 902, much as other extenders are connected to their respective gateways in the other examples described herein. However, in the example of FIG. 9, extender 908 is communicatively connected to extender 906 to extend the range of the wireless network rather than connected to gateway 902. In particular, extender 908 may be intentionally positioned outside of the effective transmission range of gateway 902. In one example, extender 908 may be positioned such that the RSSI for gateway 902 is −85 dBm or worse. Client device 910 may then be connected to extender 906 and client device 912 connected to extender 908. This configuration of devices may allow testing module 280 to evaluate how effectively the network provides service to client devices that are connected to extenders in a linear topology relative to the gateway (e.g., extender 908).

Testing module 280 may then perform connectivity throughput tests on client device 910, optionally recording a variety of other information relevant to these tests, such as RSSIs at each client device and/or access point, channels used, and/or network topology. Once testing of client device 910 has concluded, testing module 280 may then perform the same tests on client device 912. Testing module 280 may also perform network connectivity tests on multiple connected client devices simultaneously to test how the network distributes resources across the different devices. For example, testing module 280 may perform connectivity tests on client device 910 while simultaneously performing the same set of connectivity tests on client device 912. As before, testing module 280 may optionally record a variety of other information relevant to these tests, such as RSSIs at each client device and/or access point, channels used, and/or network topology during these connectivity throughput tests.

The particular arrangement of devices illustrated in FIG. 9 is merely one example of a possible device layout for conducting a linear topology test; a variety of other configurations could be used. For example, the test network could include three extenders (e.g., an additional extender communicatively connected to extender 908) and three client devices, one connected to each extender. However, any suitable number of extenders and/or client devices for testing linear or even branching network topologies could be used.

Testing module 280 may conduct additional tests using any of the network topologies and/or physical arrangements of devices discussed above (or any other suitable arrangement of devices). For example, testing module 280 may check to see whether the network is capable of dynamic frequency selection (DFS) functionality to escape interference. In this example, testing module 280 may use recorded network topologies and channel usage during the above-described network interference tests to determine whether the network is capable of supporting DFS. In some embodiments (e.g., in the US, EU, and/or Japan), for example, any 5 GHz Wi-Fi channel between 52 and 140 (inclusive) may be considered a DFS channel. For example, any of the existing (or to be known/developed) dynamic frequency selection (DFS) channels in UNII-2 and/or UNII-2e space can be utilized.

Testing module 280 may also conduct prioritization tests using any of the network topologies and/or physical arrangements of devices discussed above (or any other suitable arrangement of devices). In some embodiments, testing module 280 may connect all client devices involved in a prioritization test directly to the gateway. In this test, one client device (the device under test) may perform a throughput test. The remaining client devices and/or a subset of the remaining client devices may constantly generate network traffic (e.g., ICMP pings to a router upstream of the gateway) while the device under test performs the throughput test.

In some embodiments, testing module 280 may designate a specific client device as a priority client, e.g., a client whose network connectivity should be prioritized over other clients. Testing module 280 may use any of the network configurations described herein and/or use any other suitable number or arrangement of client devices and/or extenders. Testing module 280 may then determine latencies of each client device involved in the test to verify whether network traffic for the priority client device was properly prioritized during the network test. In some examples, testing module 280 may evaluate network prioritization by causing each client device to ping a network device upstream of the gateway device at a regular interval, perform connectivity throughput tests, etc. and measuring the network performance at each client device.

For networks that support prioritization of specific devices and/or prioritization according to differing levels, testing module 280 may test the device under test at each available prioritization state and/or level, conducting a separate throughput test for each prioritization level. Similarly, the other client devices involved in the test can be assigned various prioritization levels to test the effects of prioritizing other devices on the connectivity throughput of the device under test. During this test, testing module 280 may collect a variety of information, such as connectivity throughput of the device under test, network topologies, channels used, client RSSI, and/or latency.

In FIG. 3 at step 360, one or more of the systems described herein may cause control of one or more of the one or more client devices, the one or more network extenders, or the network gateway based on the determined connectivity throughput. For example, controlling module 290 may, as part of gateway 202 in FIG. 2, cause control of one or more of gateway 202, extender 206, extender 208, client device 210, and/or client device 212 based on the determined connectivity throughput for each client device.

Controlling module 290 may perform a variety of functions as part of causing control of one or more of the devices described herein. For example, controlling module 290 may reconfigure one or more of the client devices, one or more of the extenders, and/or the network gateway based on the connectivity throughput (or any other network metric) of the communicative connections between client devices and extenders as measured during the tests described herein. As some specific examples, controlling module 290 may cause control of one or more client devices to change how those devices choose which extender to connect to (e.g., preferentially connect to extenders that provide higher throughput connections vs. whichever extender in range was connected to most recently). As an additionally example, controlling module 290 may cause control of one or more extenders to change how those extenders propagate network signals throughout the service area and/or how those extenders connect to other access points in the network (e.g., connecting to any other extender in range vs. minimizing the length of linear topologies, etc.). Furthermore, controlling module 290 may cause control of gateway 202 to alter how gateway 202 manages network 204 (e.g., changing packet routing preferences, reconfiguring network communication protocols, etc.).

The results of the testing procedures described above can also be used to inform future designs of networking hardware, such as gateways and/or access points, and/or the control software and/or firmware for networking hardware. Identifying weak points in how network hardware responds to unusual conditions may allow engineers to design solutions to those problems. For example, if a certain design of networking hardware does not respond well to external interference, future designs of the hardware might include expanded DFS capabilities, software or firmware that more efficiently manages client connections to switch to channels with less interference, etc.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of” Finally, for ease of use, the terms “including” and “having” (and their derivatives), as used in the specification and claims, are interchangeable with and have the same meaning as the word “comprising.”

What is claimed is:

1. A computer-implemented method, the computer-implemented method comprising:
configuring, via a network gateway, a wireless network;
communicatively connecting, via the wireless network, one or more network extenders to the network gateway;
communicatively connecting, via the wireless network, one or more client devices to an access point comprising at least one of:
at least one of the one or more network extenders; or
the network gateway;
performing one or more network test operations on the wireless network;
determining, during each of the one or more network test operations and for each of the one or more client devices, a connectivity throughput of the communicative connection between each client device and the wireless network; and
causing control of one or more of the one or more client devices, the one or more network extenders, or the network gateway based on the determined connectivity throughput between each client device and the wireless network.

2. The computer-implemented method of claim 1, wherein causing control of one or more of the one or more client devices, the one or more network extenders, or the network gateway comprises reconfiguring, based on the connectivity throughput of the communicative connection between the client device and the wireless network during each of the one or more network test operations, one or more of the network gateway or at least one of the one or more network extenders.

3. The computer-implemented method of claim 1, further comprising determining, for each of the one or more client devices and prior to performing the one or more network test operations, a baseline connectivity throughput of the communicative connection between the client device and the wireless network.

4. The computer-implemented method of claim 1, further comprising, for a subset of the one or more network test operations, determining a connection latency of the communicative connection between the client device and the wireless network.

5. The computer-implemented method of claim 1, further comprising:
mapping, for a subset of the one or more network test operations and prior to performing each of the subset of the one or more network test operations, a pre-test network topology of the wireless network; and
mapping, for the subset of the one or more network test operations and after performing each of the subset of the one or more network test operations, a post-test network topology of the wireless network.

6. The computer-implemented method of claim 1, wherein performing the one or more network test operations comprises:
configuring an additional wireless network that overlaps with the wireless network and uses a same channel as the wireless network; and
generating, by the additional wireless network, interference that interferes with operation of the wireless network.

7. The computer-implemented method of claim 6, wherein generating the interference comprises generating interference on a channel that carries backhaul communications between the one or more network extenders and the network gateway.

8. The computer-implemented method of claim 6, wherein generating the interference comprises generating interference on a channel that carries communications between the one or more client devices and the access point.

9. The computer-implemented method of claim 1, wherein performing the one or more network test operations comprises:
positioning at least one client device near a particular network extender of the one or more network extenders such that a difference between a received signal strength at the at least one client device from the particular network extender and a received signal strength at the at least one client device from the network gateway is less than a threshold amount;
connecting the at least one client device to the wireless network;
mapping a network topology of the wireless network; and
determining which access point the at least one client device is connected to.

10. The computer-implemented method of claim 1, wherein performing the one or more network test operations comprises:
connecting a specific client device to the wireless network;
transmitting network pings, from the specific client device, to a network device upstream of the wireless network at specified intervals while moving the specific client device through space around a periphery of a physical area covered by the wireless network;
detecting, while moving the specific client device through space, that the specific client device has reconnected to a new access point; and
determining a number of network pings that fail to reach the network device upstream of the wireless network when the specific client device reconnects to the new access point.

11. The computer-implemented method of claim 1, wherein performing the one or more network test operations comprises:
distributing the one or more client devices around a periphery of a physical area covered by the wireless network; and
determining, at each client device, a received signal strength of the wireless network.

12. The computer-implemented method of claim 1, wherein performing the one or more network test operations comprises:
communicatively connecting, by the wireless network, a first network extender to the network gateway;
communicatively connecting, by the wireless network, a second network extender to the first network extender;
communicatively connecting, by the wireless network, a first client device to the first network extender and a second client device to the second network extender; and
determining a connection throughput of the communicative connection between the first client device and the wireless network, and further determining a connection throughput of the communicative connection between the second client device and the wireless network.

13. The computer-implemented method of claim 1, wherein:
performing the one or more network test operations comprises designating a specific client device in the one or more client devices as a priority client; and
determining the connectivity throughput of the communicative connection between each client device and the wireless network comprises determining a latency of the communicative connection.

14. A system comprising:
at least one physical processor; and
a computer-readable storage medium storing computer-executable instructions that, when executed by the at least one physical processor, cause the at least one physical processor to performing operations including:
configuring, via a network gateway, a wireless network;
communicatively connecting, via the wireless network, one or more network extenders to the network gateway;
communicatively connecting, via the wireless network, one or more client devices to an access point comprising at least one of:
at least one of the one or more network extenders; or
the network gateway;
performing one or more network test operations on the wireless network;
determining, during each of the one or more network test operations and for each of the one or more client devices, a connectivity throughput of the communicative connection between each client device and the wireless network; and
causing control of one or more of the one or more client devices, the one or more network extenders, or the network gateway based on the determined connectivity throughput between each client device and the wireless network.

15. The system of claim 14, the operations further comprising reconfiguring, based on the connectivity throughput of the communicative connection between the client device and the wireless network during each of the one or more network test operations, one or more of the network gateway or at least one of the one or more network extenders.

16. The system of claim 14, the operations further comprising determining, for each of the one or more client devices and prior to performing the one or more network test operations, a baseline connectivity throughput of the communicative connection between the client device and the wireless network.

17. The system of claim 14, the operations further comprising, for a subset of the one or more network test operations, determining a connection latency of the communicative connection between the client device and the wireless network.

18. The system of claim 14, the operations further comprising:
mapping, for a subset of the one or more network test operations and prior to performing each of the subset of the one or more network test operations, a pre-test network topology of the wireless network; and
mapping, for the subset of the one or more network test operations and after performing each of the subset of the one or more network test operations, a post-test network topology of the wireless network.

19. The system of claim 14, wherein performing the one or more network test operations comprises:
configuring an additional wireless network that overlaps with the wireless network and uses a same channel as the wireless network; and
generating, by the additional wireless network, interference that interferes with operation of the wireless network.

20. A computer-readable storage medium storing computer-executable instructions that, when executed by at least one processor of a computing device, cause the at least one processor to performing operations including:
configuring, via a network gateway, a wireless network;
communicatively connecting, via the wireless network, one or more network extenders to the network gateway;
communicatively connecting, via the wireless network, one or more client devices to an access point comprising at least one of:
at least one of the one or more network extenders; or
the network gateway;
performing one or more network test operations on the wireless network;
determining, during each of the one or more network test operations and for each of the one or more client devices, a connectivity throughput of the communicative connection between each client device and the wireless network; and
causing control of one or more of the one or more client devices, the one or more network extenders, or the network gateway based on the determined connectivity throughput between each client device and the wireless network.
